(19) United States
(12) Patent Application Publication
(10) Pub. No.: US 2025/0008558 A1
(43) Pub. Date: Jan. 2, 2025

(54) Sidelink Transmission in Unlicensed Spectrum

(71) Applicant: Telefonaktiebolaget LM Ericsson (publ), Stockholm (SE)

(72) Inventor: Min Wang, Luleå (SE)

(21) Appl. No.: 18/690,361

(22) PCT Filed: Sep. 13, 2022
(86) PCT No.: PCT/EP2022/075398

§ 371 Date: Mar. 8, 2024

(30) Foreign Application Priority Data
Sep. 13, 2021 (WO) PCT/EP2021/075141

(51) Int. Cl. H04W 74/0808; H04W 16/14; H04W 92/18

(52) U.S. Cl. CPC H04W 74/0808; H04W 16/14; H04W 92/18

(57) ABSTRACT

The disclosure provides, inter alia, a method performed by a first user equipment (UE). The method comprises: determining resources in unlicensed spectrum on which to transmit to one or more second UEs over a sidelink connection; and using the determined resources to initiate a transmission within a channel occupancy time for the transmission.

### TECHNICAL FIELD

Embodiments of the disclosure relate to wireless communications, and particularly to methods, apparatus and computer-readable media for configuring, performing and/or receiving sidelink transmissions using unlicensed spectrum.

### BACKGROUND

### NR Based Access to Unlicensed Spectrum

Next generation systems are expected to support a wide range of use cases with varying requirements ranging from fully mobile devices to stationary IoT or fixed wireless broadband devices. The traffic pattern associated with many use cases is expected to consist of short or long bursts of data traffic with varying length of waiting period in between (here called inactive state). In NR, both license assisted access and standalone unlicensed operation are to be supported in 3GPP. Hence the procedure of PRACH transmission and/or SR transmission in unlicensed spectrum shall be investigated in 3GPP. In the following, NR-U and channel access procedure for an unlicensed channel based on LBT is introduced.

### NR-U Introduction

In order to tackle the demand for ever-increasing data, NR is supported on both licensed and unlicensed spectrum (i.e., referred to as NR-U). Compared to LTE LAA, NR-U supports DC and standalone scenarios, where MAC procedures including RACH and scheduling procedure on unlicensed spectrum are subject to LBT failures, whereas there was no such restriction in LTE LAA, since there was licensed spectrum in LAA scenario so RACH and scheduling related signaling could be transmitted on the licensed spectrum instead of unlicensed spectrum.

For discovery reference signal (DRS) transmission such as PSS/SSS, PBCH, CSI-RS, control channel transmission such as PUCCH/PDCCH, physical data channel such as PUSCH/PDSCH, and uplink sounding reference signal such as SRS transmission, channel sensing should be applied to determine the channel availability before the physical signal is transmitted using the channel.

The RRM procedures in NR-U would be generally rather similar as in LAA, since NR-U is aiming to reuse LAA/eLAA/feLAA technologies as much as possible to handle the coexistence between NR-U and other legacy RATs. RRM measurements and report comprising special configuration procedure with respect the channel sensing and channel availability.

Hence, channel access/selection for LAA was one of important aspects for co-existence with other RATs such as Wi-Fi. For instance, LAA has aimed to use carriers that are congested with Wi-Fi.

In licensed spectrum, UE measures Reference Signal Received Power (RSRP), and Reference Signal Received Quality (RSRQ) of the downlink radio channel (e.g. SSB, CSI-RS), and provides the measurement reports to its serving eNB/gNB. However, they don't reflect the interference strength on the carrier. Another metric Received Signal Strength Indicator (RSSI) can serve for such purpose. At the eNB/gNB side, it is possible to derive RSSI based on the received RSRP and RSRQ reports, however, this requires that they must be available. Due to the LBT failure, some reports in terms of RSRP or RSRP may be blocked (can be either due to that the reference signal transmission (DRS) is blocked in the downlink or the measurement report is blocked in the uplink). Hence, the measurements in terms of RSSI are very useful. The RSSI measurements together with the time information concerning when and how long time that UEs have made the measurements can assist the gNB/eNB to detect the hidden node. Additionally, the gNB/eNB can measure the load situation of the carrier which is useful for the network to prioritize some channels for load balance and channel access failure avoidance purposes.

LTE LAA has defined to support measurements of averaged RSSI and channel occupancy) for measurement reports. The channel occupancy is defined as percentage of time that RSSI was measured above a configured threshold. For this purpose, a RSSI measurement timing configuration (RMTC) includes a measurement duration (e.g. 1-5 ms) and a period between measurements (e.g. {40, 80, 160, 320, 640} ms).

Access to a channel in the unlicensed spectrum, especially in the 5 GHz and 6 GHz band, is guaranteed by Listen Before Talk (LBT) requirements defined by regulations, unlike licensed spectrum which is assigned to a specific operator.

The LBT mechanism mandates a device to sense for the presence of other users' transmissions in the channel before attempting to transmit. The device performs clear channel assessment (CCA) checks on the channel using energy detection (ED) before transmitting. If the channel is found to be idle, i.e. energy detected is below a certain threshold, the device is allowed to transmit. Otherwise, if the channel is found to be occupied, the device must defer from transmitting. This mechanism reduces interferences and collisions to other systems and increases probabilities of successful transmissions when the energy in a CCA slot is sensed to be below the ED threshold. Regulatory requirements in some regions specify the maximum allowed ED threshold, thus setting a limit on the most aggressive behavior transmitters may have.

As described in 3GPP TR 38.889 [3], the channel access schemes for NR-based access for unlicensed spectrum can be classified into the following categories:

Category 1: Immediate transmission after a short switching gap, i.e., also referred to as no LBT operation
This is used for a transmitter to immediately transmit after a UL/DL switching gap inside a COT.
The switching gap from reception to transmission is to accommodate the transceiver turnaround time and is no longer than 16 μs.

Category 2: LBT without random back-off (also referred to as one shot LBT)
The duration of time that the channel is sensed to be idle before the transmitting entity transmits is deterministic.

Category 3: LBT with random back-off with a contention window of fixed size
The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.

Category 4: LBT with random back-off with a contention window of variable size
The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

For different transmissions in a COT and different channels/signals to be transmitted, different categories of channel access schemes can be used.

NR-U supports two different LBT modes, dynamic and semi-static channel occupancy for two types of equipment; Load based Equipment (LBE) and Frame based equipment (FBE), respectively.

### COT Sharing in NR Unlicensed Spectrum

For a node (e.g., NR-U gNB/UE, LTE-LAA eNB/UE, or Wi-Fi AP/STA)) to be allowed to transmit in unlicensed spectrum (e.g., 5 GHz band) it typically needs to perform a clear channel assessment (CCA). This procedure typically includes sensing the medium to be idle for a number of time intervals. Sensing the medium to be idle can be done in different ways, e.g. using energy detection, preamble detection or using virtual carrier sensing. Where the latter implies that the node reads control information from other transmitting nodes informing when a transmission ends. After sensing the medium to be idle, the node is typically allowed to transmit for a certain amount of time, sometimes referred to as transmission opportunity (TXOP). The length of the

TXOP depends on regulation and type of CCA that has been performed, but typically ranges from 1 ms to 10 ms. This duration is often referred to as a COT (Channel Occupancy Time).

In Wi-Fi, feedback of data reception acknowledgements (ACKs) is transmitted without performing clear channel assessment. Preceding feedback transmission, a small time duration (called SIFS) is introduced between the data transmission and the corresponding feedback which does not include actual sensing of the channel. In 802.11, the SIFS period (16 μs for 5 GHz OFDM PHYs) is defined as:

aSIFSTime=aRxPHYDelay+aMACProcessingDelay+aRxTxTurnaroundTime
aRxPHYDelay defines the duration needed by the PHY layer to deliver a packet to the MAC layer.
aMACProcessingDelay defines the duration that the MAC layer needs to trigger the PHY layer transmitting a response
aRxTxTurnaroundTime defines the duration needed to turn the radio from reception into transmit mode

Therefore, the SIFS duration is used to accommodate for the hardware delay to switch the direction from reception to transmission.

It is anticipated that for NR in unlicensed bands (NR-U), a similar gap to accommodate for the radio turnaround time will be allowed. For example, this will enable the transmission of PUCCH carrying UCI feedback as well as PUSCH carrying data and possible UCI within the same transmit opportunity (TXOP) acquired by the initiating gNB without the UE performing clear channel assessment before PUSCH/PUCCH transmission as long as the gap between DL and UL transmission is less than or equal to 16 μs. Operation in this manner is typically called “COT sharing.” An example of COT sharing is illustrated in FIG. 1.

When UE accesses medium via Cat-4 LBT with a configured grant outside of a gNB COT, it is also possible for UE and gNB to share the UE acquired COT to schedule DL data to the same UE. UE COT information can be indicated in UCI such as CG-UCI for configured grant PUSCH resources. An example of a UE initiated COT is illustrated in FIG. 2.

### Dynamic Channel Occupancy by LBE

Rel 16 WI NR-U specifies a dynamic channel access mechanism for an LBE type device.

This procedure is designed to randomize the start of transmissions from different nodes that want to access the channel at the same time.

This procedure is commonly known as category 4 (CAT4) LBT, the detailed procedure for category 4 LBT (also named as Type 1 channel access in TS 37.213 V 16.1.0 [4]) is described below.

A UE may transmit the transmission using Type 1 channel access procedure after first sensing the channel to be idle during the slot durations of a defer duration T_d, and after the counter N is zero in step 4. The counter N is adjusted by sensing the channel for additional slot duration(s) according to the steps described below.
1) set N=N_init, where N_init is a random number uniformly distributed between 0 and CW_p, and go to step 4;
   2) if N>0 and the UE chooses to decrement the counter, set N=N−1;
      3) sense the channel for an additional slot duration, and if the additional slot duration is idle, go to step 4; else, go to step 5;
         4) if N=0, stop; else, go to step 2.
         5) sense the channel until either a busy slot is detected within an additional defer duration T_d or all the slots of the additional defer duration T_d are detected to be idle;
         6) if the channel is sensed to be idle during all the slot durations of the additional defer duration T_d, go to step 4; else, go to step 5.

If a UE has not transmitted a UL transmission on a channel on which UL transmission(s) are performed after step 4 in the procedure above, the UE may transmit a transmission on the channel, if the channel is sensed to be idle at least in a sensing slot duration T_sl when the UE is ready to transmit the transmission and if the channel has been sensed to be idle during all the slot durations of a defer duration T_d immediately before the transmission. If the channel has not been sensed to be idle in a sensing slot duration T_sl when the UE first senses the channel after it is ready to transmit, or if the channel has not been sensed to be idle during any of the sensing slot durations of a defer duration T_d immediately before the intended transmission, the UE proceeds to step 1 after sensing the channel to be idle during the slot durations of a defer duration T_d.

The defer duration T_d consists of duration T_f=16 us immediately followed by m_p consecutive slot durations where each slot duration is T_sl=9 us, and T_f includes an idle slot duration T_sl at start of T_f.

CW_{min,p}≤CWₚ≤CW_{max,p} is the contention window. CWₚ adjustment is described in clause 4.2.2.

CW_{min,p} and CW_{max,p} are chosen before step 1 of the procedure above.

mₚ, CW_{min,p}, and CW_{max,p} are based on a channel access priority class p as shown in Table 1/Table 4.2.1-1 in TS 37.214 [3].

TABLE 1
Table 4.2.1-1: Channel Access Priority
Class (CAPC) for UL in TS 37.214 [3]

| Channel | | | | | |
|---|---|---|---|---|---|
| Access | | | | | |
| Priority | | | | | allowed CWₚ |
| Class (p) | mₚ | CWₘ | CW_{max, p} | T_{ulmcot, p} | sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, |
| | | | | | 255, 511, 1023} |
| 4 | 7 | 15 | 1023 | 6 ms or 10 ms | {15, 31, 63, 127, |
| | | | | | 255, 511, 1023} |

NOTE1:
For p = 3, 4, T_{ulmcot, p} = 10 ms if the higher layer parameter absenceOfAnyOtherTechnology-r14 or absenceOfAnyOtherTechnology-r16 is provided, otherwise, T_{ulmcot, p} = 6 ms.
NOTE 2:
When T_{ulmcot, p} = 6 ms it may be increased to 8 ms by inserting one or more gaps. The minimum duration of a gap shall be 100 us. The maximum duration before including any such gap shall be 6 ms.

### Semi-Static Channel Occupancy by FBE

The Semi-static channel occupancy allows a Frame based equipment (FBE) to perform a clear channel assessment per fixed frame period for a duration of single 9 us observation slot. If the channel is found to be busy after CCA operation, the equipment shall not transmit during this fixed frame period. The fixed frame period can be set to a value between 1 and 10 ms and can be adjusted once every 200 ms. If the channel is found to be idle, the equipment can transmit immediately up to a duration referred to as channel occupancy time, after which the equipment shall remain silent for at least 5% of said channel occupancy time. At the end of the required idle period, the equipment can resume CCA for channel access. An example of the FBE based channel occupancy operation is shown in FIG. 3.

Semi-static channel occupancy generally has difficulty competing with devices that use dynamic channel occupancy (such as LAA or NR-U) for channel access. Dynamic channel occupancy device has the flexibility to access the channel at any time after a successful LBT procedure, while semi-static channel occupancy devices have one chance for grabbing the channel every fixed frame period. The problems become more exacerbated with longer fixed frame period and higher traffic load. Secondly, the frame based LBT can be rather inflexible for coordinating channel access between networks. If all the nodes are synchronized, then all nodes will find the channel available and transmit simultaneously and cause interference. If the nodes are not synchronized, then some nodes may have definitive advantages in getting access to the channel over some other nodes. Nonetheless, semi-static channel occupancy can be good choice for controlled environments, where a network owner can guarantee absence of dynamic channel occupancy devices and is in control of the behavior of all devices competing to access the channel. In fact, in such deployment, semi-static channel occupancy is an attractive solution because access latencies can be reduced to the minimum and lower complexity is required for channel access due to lack of necessity to perform random backoff.

It has been identified that FBE operation for the scenario where it is guaranteed that LBE nodes are absent on a long-term basis (e.g., by level of regulation) and FBE gNBs are synchronized can achieve the following:
Ability to use frequency reuse factor 1;
Lower complexity for channel access due to lack of necessity to perform random backoff.
   It is noted that this does not imply that LBE does not have benefits in similar scenarios although there are differences between the two modes of operation. It is also noted that FBE may also have some disadvantages compared to other modes of operation such as LBE, e.g., a fixed overhead for idle time during a frame.

In order to deploy a single operator FBE system, the gNBs need to be time aligned. All gNBs will perform the one-shot 9 us LBT at the same time. If the gNB indicates FBE operation, for an indication of LBT type of Cat2 25 us or Cat4 the UE follows the mechanism whereby one 9 microsecond slot is measured within a 25-microsecond interval.

The fixed frame period (FFP) is restricted to values of {1 ms, 2 ms, 2.5 ms, 4 ms, 5 ms, 10 ms} (this is including the idle period). The starting positions of the FFPs within every two radio frames starts from an even radio frame and are given by i*P where i={0,1, . . . , 20/P−1} where P is the fixed frame period in ms.

The idle period for a given SCS=ceil (Minimum idle period allowed by regulations/Ts) where minimum idle period allowed=max(5% of FFP, 100 us), and Ts is the symbol duration for the given SCS.

For FBE, channel sensing is performed at fixed time instants. If the channel is determined busy, the base station adopts a fixed back-off and perform LBT again after the fixed backoff. For LBE, channel sensing can be performed at any time instance, and random back-off is adopted when the channel is determined to be busy.

In NR Rel-16, it is only gNB COT sharing that is supported in case of semi-static channel access by FBE. A UE may transmit UL transmission burst(s) after DL transmission within a gNB initiated COT. UE transmissions within a fixed frame period can occur if DL transmission for the serving gNB within the fixed frame period are detected. The detection of any DL transmission confirms that the gNB has initiated the COT. For this to work, the UE should be aware of the start and end of every FFP cycle. Such UE behaviors are not optimum for URLLC like services which require critical latency requirements. UE initiated COT by FBE would be a complementary solution for URLLC.

### Side Link Transmission in NR

Sidelink transmissions over NR are specified for Rel. 16. These are enhancements of the ProSe (PROximity-based SErvices) specified for LTE. Four new enhancements are particularly introduced to NR sidelink transmissions as follows:

Support for unicast and groupcast transmissions are added in NR sidelink. For unicast and groupcast, the physical sidelink feedback channel (PSFCH) is introduced for a receiver UE to reply the decoding status to a transmitter UE.

Grant-free transmissions, which are adopted in NR uplink transmissions, are also provided in NR sidelink transmissions, to improve the latency performance.

To alleviate resource collisions among different sidelink transmissions launched by different UEs, it enhances channel sensing and resource selection procedures, which also lead to a new design of PSCCH.

To achieve a high connection density, congestion control and thus the QoS management is supported in NR sidelink transmissions.

To enable the above enhancements, new physical channels and reference signals are introduced in NR (available in LTE before):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink feedback channel): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another new feature is the two-stage sidelink control information (SCI). This a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as a 8-bits source identity (ID) and a 16-bits destination ID, NDI, RV and HARQ process ID is sent on the PSSCH to be decoded by the receiver UE.

Similar as for PRoSE in LTE, NR sidelink transmissions have the following two modes of resource allocations:
Mode 1: Sidelink resources are scheduled by a gNB.
Mode 2: The UE autonomously selects sidelink resources from a (pre-)configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:

Dynamic grant: When the traffic to be sent over sidelink arrives at a transmitter UE, this UE should launch the four-message exchange procedure to request sidelink resources from a gNB (SR on UL, grant, BSR on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

### SUMMARY

There currently exist certain challenge(s). Sidelink transmissions on unlicensed spectrum is an area of future development. As used herein, the term “unlicensed spectrum” may be understood as corresponding to spectrum which is accessible or useable by more than one non-cooperative radio-access technologies (RATs). Thus devices employing different RATs contend for access to the spectrum.

In order to support sidelink transmission on unlicensed spectrum (SL-U), a channel access mechanism as in NR-U needs to be introduced for SL-U. With channel access mechanism, a SL capable UE may need to perform LBT operation prior to a SL transmission. However, the controlling mechanisms and signalling alternatives for the Uu interface (i.e., UE to gNB) cannot be directly reused for SL transmissions. Therefore, it is necessary to study the issues and design corresponding solutions for SL transmissions on unlicensed bands.

Certain aspects of the disclosure and their embodiments may provide solutions to these or other challenges.

A first aspect provides a method performed by a first UE. The method comprises: determining resources in unlicensed spectrum on which to transmit to one or more second UEs over a sidelink connection; and using the determined resources to initiate a transmission within a channel occupancy time.

A second aspect provides a method performed by a second UE. The method comprises: receiving, from a first UE over a sidelink connection using unlicensed spectrum, configuration information for a channel occupancy time within which the first UE is to transmit on the sidelink connection.

A third aspect provides a method performed by a network node. The method comprises: transmitting, to a first UE, configuration information for a sidelink connection over which the first UE is to transmit to one or more second UEs using unlicensed spectrum.

Various signaling alternatives are proposed for SL transmissions on unlicensed band:
1. For dynamic SL grant using Mode 1 resource allocation, configuration on channel access type/LBT category is signaled in the DCI
2. For configured grant Type 1, configuration on channel access type/LBT category is signaled in the RRC signaling
3. For any SL grant including dynamic grant, configured SL grants (including Type 1 configured grant, and Type 2 configured grant), or SL grants obtained by the UE itself via Mode 2 resource allocation, one or multiple tables are defined to indicate the mapping between CAPC values and PQIs. These tables are applicable by the UE to determine or select CAPC for a SL transmission when the CAPC is not indicated/signaled to the UE by the gNB or another controlling UE, in other words, for a flow/DRB associated with a PQI, any configured/signaled CAPC value may override the CAPC value defined in the table.
4. upon obtaining an SL grant, the UE determines the channel access type for the SL grant and signals at least one of the following pieces of information to the UEs in the proximity:
   Channel access category/LBT type that the UE has performed to initiate the COT
   CAPC of the LBT category that the UE has performed to initiate the COT
   Whether COT is allowed to be shared
   In case the COT is shared to the other UEs, channel access category/LBT type is allowed to use by the other UEs prior to their transmissions when occupying the COT
   In case the COT is shared to the other UEs, whether CP extension is enabled and how CP extension is performed by the other UEs prior to their transmissions when occupying the COT

At least one of the preceding information types may be transmitted via at least one of the following signaling mechanisms prior to initiating the SL transmission using the SL grant:
MAC CE. MAC CE may be transmitted ahead of the SL transmission using another grant. Alternatively, the MAC CE is transmitted together with the data using the SL grant.
L1 signaling on channels such as PSSCH, PSCCH. The signaling may be carried in the SCI

Certain embodiments may provide one or more of the following technical advantage(s). For example, some embodiments enable the network (e.g., a network node, such as a gNB) to control channel access/LBT for SL transmissions in case of Mode 1 scheduling. Other embodiments define rules for SL transmissions to determine channel access priority class, particularly in case where there is no signaling (e.g., of the channel access priority class) received in the DCI.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 shows transmission opportunities (TXOP) both with and without COT sharing where CCA is performed by the initiating node (gNB). For the case of COT sharing the gap between DL and UL transmission is less than 16 us.

FIG. 2 shows an example of a UE COT sharing with the DL transmission. For the case of COT sharing the gap between UL and DL transmission is less than 16 us.

FIG. 3 shows semi-static channel occupancy operation.

FIGS. 4 to 6 are flow charts illustrating methods in accordance with some embodiments.

FIG. 7 shows an example of a communication system in accordance with some embodiments.

FIG. 8 shows a UE in accordance with some embodiments.

FIG. 9 shows a network node in accordance with some embodiments.

FIG. 10 is a block diagram of a host.

FIG. 11 is a block diagram illustrating a virtualization environment in which functions implemented by some embodiments may be virtualized.

FIG. 12 shows a communication diagram of a host communicating via a network node with a UE over a partially wireless connection in accordance with some embodiments.

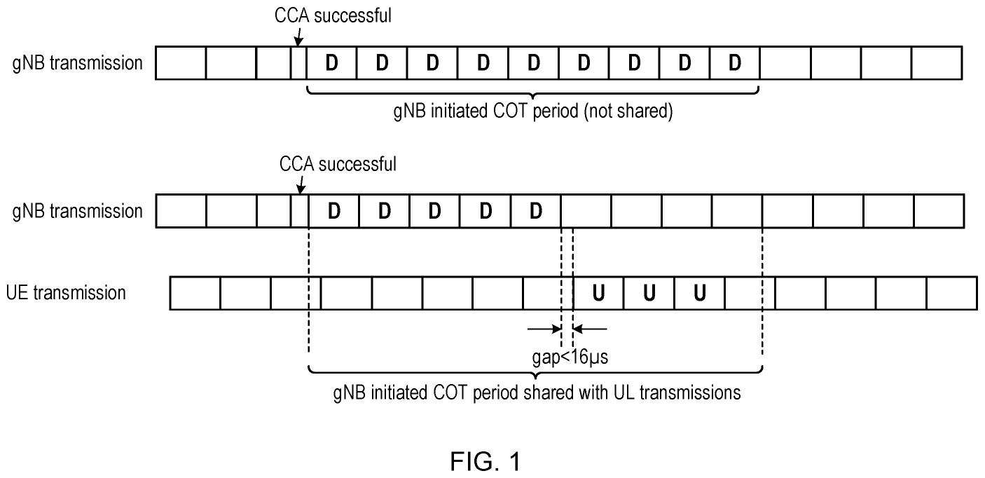

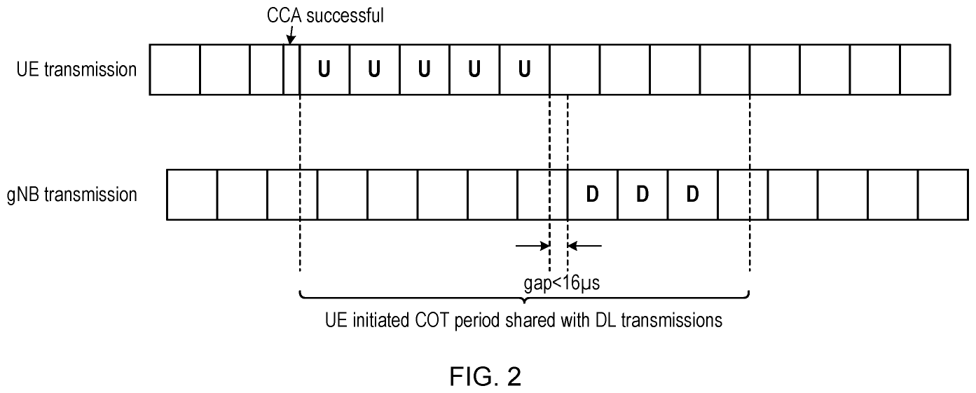

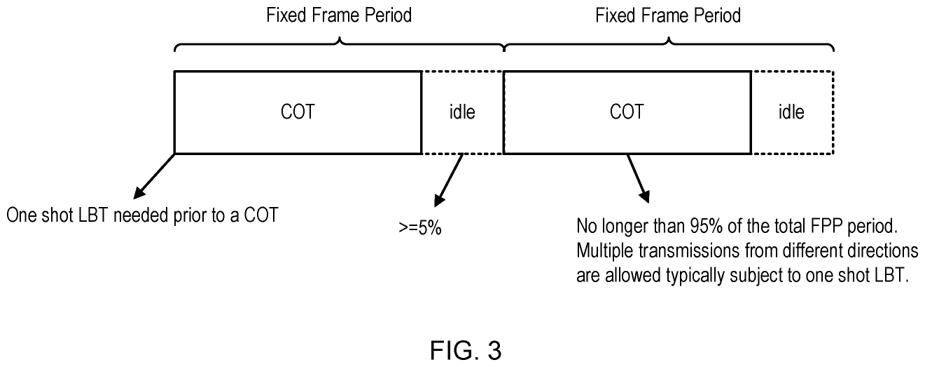

### DETAILED DESCRIPTION

Some of the embodiments contemplated herein will now be described more fully with reference to the accompanying drawings. Embodiments are provided by way of example to convey the scope of the subject matter to those skilled in the art.

The embodiments are described in the context of NR, i.e., two or more SL UEs are deployed in a same or different NR cell. However, the same principle may be applied to LTE or any other technology that enables the direct connection of two (or more) nearby devices. The embodiments are also applicable to relay scenarios including UE to network relay or UE to UE relay where the remote UE and the relay UE may be based on LTE sidelink or NR sidelink, the Uu connection between the relay UE and the base station may be LTE Uu or NR Uu.

The proposed mechanisms are applicable to SL unlicensed operations (i.e., SL transmission on unlicensed band). The term LBT may also interchangeably called as clear channel assessment (CCA), shared spectrum access procedure etc. The carrier on which the LBT is applied may belong to a shared spectrum or an unlicensed band or band with contention based access etc.

The configurable LBT schemes comprise at least one of the below LBT categories/types, but not limited to the following examples;

Category 1: Immediate transmission after a short switching gap, i.e., also referred to as no LBT operation
This is used for a transmitter to immediately transmit after a UL/DL switching gap inside a COT.
The switching gap from reception to transmission is to accommodate the transceiver turnaround time and is no longer than 16 μs.

Category 2: LBT without random back-off (also referred to as one shot LBT)
The duration of time that the channel is sensed to be idle before the transmitting entity transmits is deterministic.

Category 3: LBT with random back-off with a contention window of fixed size
The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.

Category 4: LBT with random back-off with a contention window of variable size
The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

The other LBT schemes such as directional LBT, omni directional LBT, or receiver assisted LBT are also applicable.

The LBT schemes may be also referred to as other terms e.g., Type 1 or Type 2 channel access procedures as specified in the TS 37.213 v 16.6.0.

Note: in the existing unlicensed operation technologies (e.g., LTE unlicensed operation or NR unlicensed operation), When the gap from the end of a first transmission in one direction (e.g., from UE1 to UE2) to the beginning of a second transmission in the other direction (e.g., from UE2 to UE1) is not more than a fixed period (e.g., 16 us or 25 us). Either Category 1 or Category 2 LBT can be chosen prior to the second transmission to avoid latency incurred by usage of Category 4 LBT operations. For SL transmissions, similar gap periods may be also introduced. However, the value of the gap period may be different from the ones used in the existing unlicensed operation technologies.

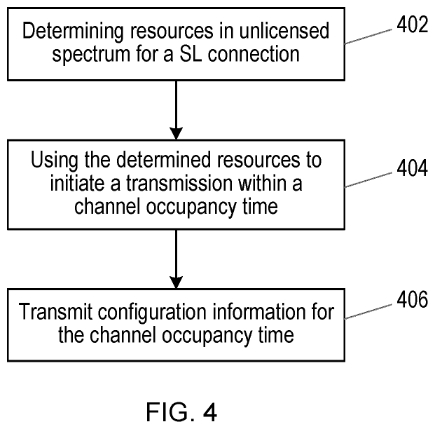

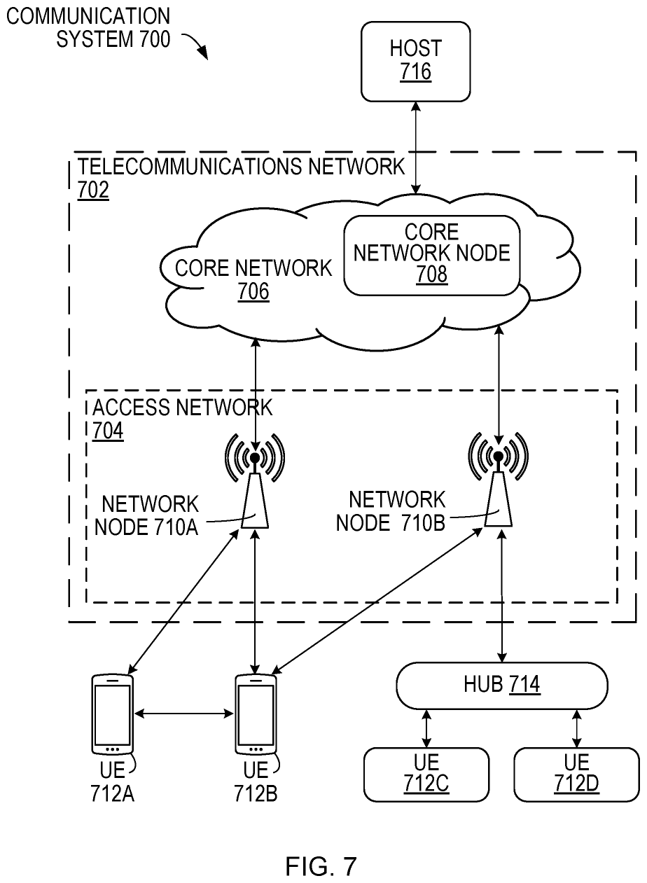

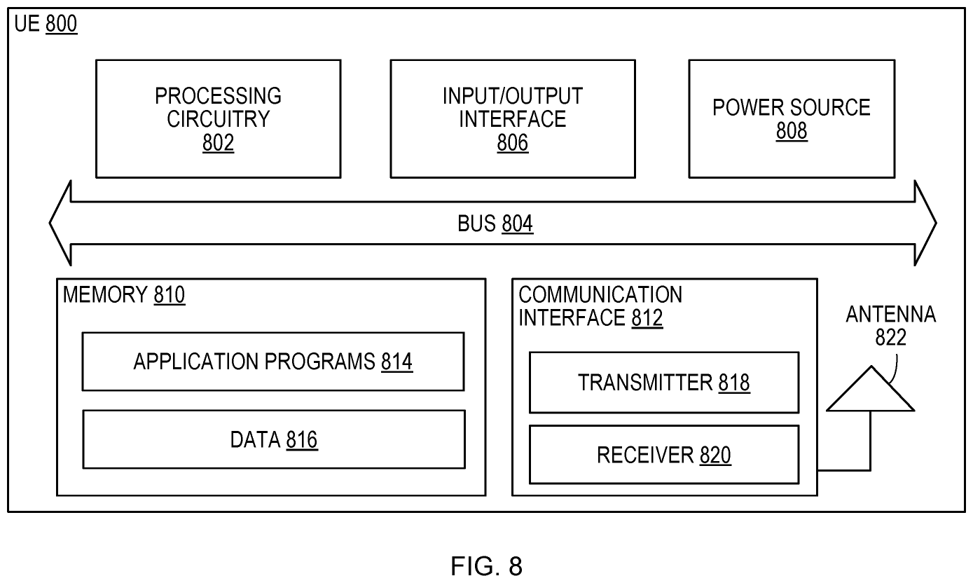

FIG. 4 depicts a method in accordance with particular embodiments. The method may be performed by a first UE or wireless device (e.g. the UE 712 or UE 800 as described later with reference to FIGS. 7 and 8 respectively). The first UE may be operable to initiate communication over a sidelink connection with one or more second UEs, e.g., by transmitting to the one or more second UEs wirelessly over a sidelink connection. According to embodiments of the disclosure, the sidelink connection utilizes unlicensed spectrum, and thus the transmission over the sidelink connection utilizes or initiates a channel occupancy time (COT).

The method begins at step 402 in which the first UE determines resources in unlicensed spectrum on which to transmit to one or more second UEs over a sidelink connection.

The resources may be determined based on a scheduling message from a network node (e.g., network node 710) comprising an indication of the resources which have been granted to the UE for the sidelink transmission. This method of resource allocation may be known as “Mode 1” scheduling or resource allocation. Alternatively, the resources may be determined autonomously by the first UE, selected from one or more (pre-)configured sidelink resource pools. This method of resource allocation may be known as “Mode 2” scheduling or resource allocation.

Mode 1 resource allocation supports dynamic grant and configured grant. Dynamic grant may involve a process in which the first UE requests a grant of resources on which to transmit, and then receives the grant of resources from the network node. The process may involve four steps, in which the first request for resources comprises a scheduling request, with the subsequently granted resources then being used to transmit a buffer status report comprising an indication of the amount of data the first UE has to send over the sidelink connection. In the fourth step, the network node grants resources suitable for the transmission of the indicated amount of data. A configured grant of resources comprises periodic resources granted to the first UE for transmission, without the first UE having to request those resources separately each time that it has data to transmit.

In some embodiments, therefore, step 402 comprises the first UE receiving, from a network node (e.g., its serving base station or gNB), a grant of resources in unlicensed spectrum on which to transmit to the one or more second UEs. The grant of resources may be indicated in downlink control information (DCI) transmitted on a downlink control channel, such as PDCCH.

According to some embodiments of the disclosure, the first UE additionally receives configuration information for the grant of resources, defining how the first UE (and potentially the one or more second UEs) are to utilize the granted resources.

For example, when the first UE obtains dynamic SL grants via Mode 1 resource allocation, i.e., the network node assigns the SL grants to the UE, the network node may additionally indicate one or more of the following parameters to the UE:
Channel access categories/LBT types that the UE shall apply prior to transmissions using the grants. Examples of channel access categories include: not performing a clear channel assessment; switching between transmitting and receiving transmissions over the sidelink connection during the channel occupancy time without performing a clear channel assessment; performing a clear channel assessment prior to transmitting over the sidelink connection; performing a clear channel assessment and performing random back-off with a fixed-size contention window prior to transmitting over the sidelink connection; performing a clear channel assessment and performing random back-off with a variable-sized contention window prior to transmitting over the sidelink connection.
Channel access priority classes that the UE shall apply for the selected channel access category/LBT type prior to transmissions using the grants. Each channel access priority class (CAPC) may define one or more of: a defer time (e.g., the length of time the channel should be sensed as being idle before being deemed idle); a minimum contention window size; a maximum contention window size; a maximum COT duration.
Whether cyclic prefix (CP) extension is enabled and how CP extension is performed. The CP may be extended to align a channel sensing interval with an OFDM symbol boundary, or to give UEs more time before switching from DL to UL.

This information may be provided in the same message as the grant of resources, e.g., in the DCI on the PDCCH (e.g., with Format 3_0 or Format 3_1)

In case of configured grant Mode 1, the network node may indicate at least one of the above information (e.g., channel access categories or LBT types; CAPC; and/or CP extension information) in RRC signaling.

In case the gNB assigns more than one SL grant to the first UE, this information (e.g., the channel access categories or LBT types, etc) may be different for different SL transmissions. In other words, prior to the first SL transmission, the UE may apply a first LBT type, whereas prior to a subsequent SL transmission, a second LBT type different from the first LBT type may be applied.

For Mode 2 resource allocation, such configuration information may be signalled to the first UE by the network node when configuring the pools of resources from which the first UE selects resources on which to transmit.

Thus the channel access priority class for the transmission over the sidelink connection may be signalled to the first UE. The Channel Access Priority Classes (CAPC) of radio bearers and MAC CEs may be fixed or configurable. For example, where the transmission comprises signalling radio bearers (SRBs) and/or MAC control elements (CES) the CAPCs may be fixed to the highest priority of the possible values for CAPC.

Alternatively, a specific type of SRB or MAC CE may be fixed or configured to a specific priority or CAPC, e.g., perhaps not the highest value.

The priority and/or CAPC for any SRB or MAC CE may be configured to the first UE by the gNB or another controlling UE. The configured priority can override any existing preconfigured/fixed priority value.

When choosing the CAPC of a data radio bearer (DRB), the network node may take into account quality-of-service parameters associated with the flows multiplexed in that DRB, such as the SL 5G QoS parameters, e.g., PC5 QOS Identifier (PQI), where PC5 is the interface between UEs. The network node may additionally consider fairness between different traffic types and transmissions.

Four possible mappings between CAPC values and QoS parameters (which is PQI in the examples) are shown in the following tables. The tables thus show which CAPC should be used for which standardized PQIs, i.e., which CAPC to use for a given QoS flow.

NOTE: A QoS flow corresponding to a non-standardized PQI (i.e. operator specific PQI) may use the CAPC of the standardized PQI which best matches the QoS characteristics of the non-standardized PQI.

TABLE 1
Mapping between Channel Access Priority Classes and PQI

| CAPC | PQI |
|---|---|
| 1 | 21, 55, 56, 57, 90, 91 |
| 2 | 22 |
| 3 | 23, 58 |
| 4 | 59 |

NOTE:
lower CAPC value means higher priority

TABLE 2
Mapping between Channel Access Priority Classes and PQI

| CAPC | PQI |
|---|---|
| 1 | 21, 22, 55, 56, 57, 90, 91 |
| 2 | 23, 58 |
| 3 | 59 |
| 4 | |

NOTE:
lower CAPC value means higher priority

TABLE 3
Mapping between Channel Access Priority Classes and PQI

| CAPC | PQI |
|---|---|
| 1 | 21, 22, 55, 56, 57, 90, 91 |
| 2 | 23, 58, 59 |
| 3 | |
| 4 | |

NOTE:
lower CAPC value means higher priority

TABLE 4
Mapping between Channel Access Priority Classes and PQI

| CAPC | PQI |
|---|---|
| 1 | 22, 55, 90, 91 |
| 2 | 21, 56, 57 |
| 3 | 23, 58, 59 |
| 4 | |

NOTE:
lower CAPC value means higher priority

Note The table may be defined considering one or more of the following
The priority level of the flow
The packet delay budget (PDB) of the flow
The packet error rate (PER) of the flow

Note Any embodiment is restricted to any example. The embodiments are also applicable to any other variant of the table.

The tables may be applicable to any SL grant including dynamic grant, configured SL grants (including Type 1 configured grant, and Type 2 configured grant), or SL grants obtained by the UE itself via Mode 2 resource allocation.

The tables may be applicable by the UE to determine or select CAPC for a SL transmission when the CAPC is not indicated/signaled to the UE by the gNB or another controlling UE, in other words, for a flow/DRB associated with a PQI, any configured/signaled CAPC value may override the CAPC value defined in the table.

There may be one or multiple tables defined to the UE. In the latter embodiments, different tables may be applicable to different scenarios. For example, different tables may apply in differing radio conditions, differing network loads, for transmissions to differing types of UE (e.g., non-machine-type UEs, machine-type UEs, etc), etc.

When the UE selects the CAPC from a table for a transmission of a MAC PDU/TB, the UE may select the CAPC according to the following rules:
If only MAC CE(s) are included in the TB, the highest priority CAPC of those MAC CE(s) is used; or
If SDU(s) of a SRB are included in the TB, the highest priority CAPC is used; or
If there is a LCH priority threshold configured, the highest priority CAPC of the logical channel(s) with LCH priority above the LCH priority threshold, and with MAC SDU multiplexed in the TB is used; or
If there is no LCH priority threshold configured, the highest priority CAPC of the logical channel(s) with MAC SDU multiplexed in the TB is used.

In step 404, the first UE performs channel access/LBT according to the received signaling (e.g., the configuration information) and, upon a successful LBT process, initiates a sidelink transmission to the one or more second UEs using the determined resources. The transmission may initiate a channel occupancy time, i.e., a period of time in which the first UE has control of (occupies) the channel.

In step 406, the first UE transmits configuration information for the channel occupancy time to the one or more second UEs.

Thus the UE determines the channel access type for the SL grant and signals configuration information over the sidelink connection to the one or more second UEs, comprising one or more of the following parameters for the channel occupancy time:
Channel access category/LBT type that the first UE has performed to initiate the COT.
CAPC of the LBT category that the first UE has performed to initiate the COT.
Whether the COT is allowed to be shared.
Where the COT may be shared with other UEs, the channel access category/LBT type to be used by the other UEs prior to their transmissions when occupying the COT.
Where the COT may be shared with other UEs, whether CP extension is enabled and how CP extension is performed by the other UEs prior to their transmissions when occupying the COT.

Here it will be noted that step 406 may be performed after step 404 (as illustrated) or before step 404. In the latter case, the configuration information may be transmitted over the sidelink connection once the first UE receives the configuration information from the network node (e.g., in step 402). In further embodiments, part of the configuration information may be transmitted over the sidelink connection prior to step 404, and another part of the configuration information transmitted over the sidelink connection after or at the same time as step 404.

Thus some or all of the configuration information may be transmitted prior to initiating the SL transmission using one or more of the following transmission types:
MAC CE. MAC CE may be transmitted ahead of the SL transmission using another grant. Alternatively, the MAC CE is transmitted together with the data using the SL grant.
L1 signaling on channels such as PSSCH, PSCCH. The signaling may be carried in the sidelink control information (SCI).

Upon reception of the configuration information, the second UEs in the proximity learn about the channel access type that will be used by the upcoming transmission by the first UE. COT sharing related information may also be carried in the signaling in the SL link (e.g., SCI). A second UE may use this configuration information for determining one or more of the following:
Whether to join/occupy the COT if it is shared by the first UE
What channel access type may be chosen by the second UE prior to its transmissions

If the COT is shared by the first UE, the second UE may determine to occupy the COT for its subsequent data transmission or reception. In this case, the second UE performs LBT operation prior to its transmissions according to the channel access type indicated in the configuration information.

Regardless of whether the COT is shared by the first UE, the other UE may determine to choose which channel access type to use for its subsequent transmission according to one or more of the following rules:
If the gap from the end of the last transmission of the first UE to the beginning of the next transmission of the second UE is not more than a first threshold value (e.g., X μs), the second UE chooses category 1 LBT; else
If the gap from the end of the last transmission of the UE to the beginning of the next transmission of the other UE is not more than a second threshold value (e.g., Y μs), the second UE chooses category 2 LBT with duration equal to Z μs (e.g., where Z≤Y).
Otherwise, the second UE may choose Category 3 or category 4 LBT.

Alternatively, the second UE may determine to choose a similar category of LBT operation as the one that the first UE has applied to initiate the COT.

The first and/or second UE in the discussion above may be load-based equipment (LBE) or operating in LBE mode.

Where the first and/or second UE are frame-based equipment (FBE) or operating in FBE mode for channel access, the configuration information transmitted by the network node to the first UE, and/or from the first UE to the one or more second UEs, may additionally or alternatively include an indication of the fixed frame period (FFP). The network node may provide the configuration to the UE via RRC signaling, or in system information.

For UEs that are out of coverage, the above configuration information may also or alternatively be preconfigured in or to the first UE.

In addition to any signaling alternative described in the above embodiments, the channel access mode (i.e., LBE or FBE) may also be configured to the first UE by the network node via RRC signaling, or in system information.

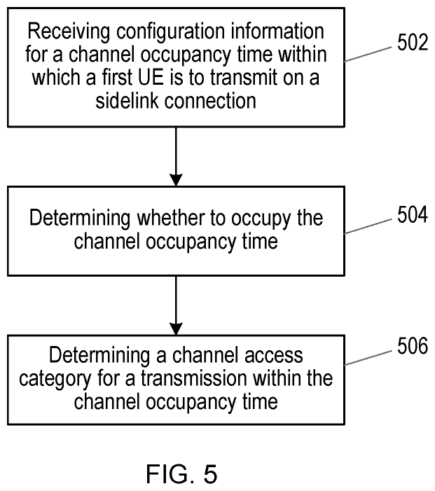

FIG. 5 depicts a method in accordance with particular embodiments. The method may be performed by a UE or wireless device (e.g. the UE 712 or UE 800 as described later with reference to FIGS. 7 and 8 respectively). In particular, the method may be performed by a second UE which receives transmissions from a first UE over a sidelink connection. At least one of the transmissions may use unlicensed spectrum.

The method begins at step 502, in which the second UE receives configuration information for a channel occupancy time which is initiated by the first UE through a transmission over the sidelink connection using unlicensed spectrum.

The configuration information may comprise one or more of the following parameters for the channel occupancy time:
Channel access category/LBT type that the first UE has performed to initiate the COT.
CAPC of the LBT category that the first UE has performed to initiate the COT.
Whether the COT is allowed to be shared.
Where the COT may be shared with other UEs, the channel access category/LBT type to be used by the other UEs prior to their transmissions when occupying the COT.
Where the COT may be shared with other UEs, whether CP extension is enabled and how CP extension is performed by the other UEs prior to their transmissions when occupying the COT.

Here it will be noted that the configuration information may be received before the COT is initiated by the first UE, or during the COT (e.g., as part of a transmission by the first UE over the sidelink connection in the COT). In further embodiments, part of the configuration information may be received over the sidelink connection prior to initiation of the COT, and another part of the configuration information received over the sidelink connection during the COT.

Thus some or all of the configuration information may be transmitted prior to initiating the SL transmission using one or more of the following transmission types:
MAC CE. MAC CE may be transmitted ahead of the SL transmission using another grant. Alternatively, the MAC CE is transmitted together with the data using the SL grant.
L1 signaling on channels such as PSSCH, PSCCH. The signaling may be carried in the sidelink control information (SCI).

Upon reception of the configuration information, the second UEs in the proximity learn about the channel access type that will be used by the upcoming transmission by the first UE. COT sharing related information may also be carried in the signaling in the SL link (e.g., SCI).

The first and/or second UE in the discussion above may be load-based equipment (LBE) or operating in LBE mode.

Where the first and/or second UE are frame-based equipment (FBE) or operating in FBE mode for channel access, the configuration information transmitted by the network node to the first UE, and/or from the first UE to the one or more second UEs, may additionally or alternatively include an indication of the fixed frame period (FFP). The network node may provide the configuration to the UE via RRC signaling, or in system information.

For UEs that are out of coverage, the above configuration information may also or alternatively be preconfigured in or to the first UE.

In addition to any signaling alternative described in the above embodiments, the channel access mode (i.e., LBE or FBE) may also be configured to the first UE by the network node via RRC signaling, or in system information.

In step 504, the second UE may use this configuration information for determining whether to join/occupy the COT if it is shared by the first UE. For example, if the configuration information indicates that the COT is shared by the first UE, the second UE may determine to occupy the COT for its subsequent data transmission or reception.

Regardless of whether the COT is shared by the first UE, the other UE may determine to choose which channel access type to use for its subsequent transmission according to one or more of the following rules:
If the gap from the end of the last transmission of the first UE to the beginning of the next transmission of the second UE is not more than a first threshold value (e.g., X μs), the second UE chooses category 1 LBT; else
If the gap from the end of the last transmission of the UE to the beginning of the next transmission of the other UE is not more than a second threshold value (e.g., Y μs), the second UE chooses category 2 LBT with duration equal to Z μs (e.g., where Z≤Y).
Otherwise, the second UE may choose Category 3 or category 4 LBT.

In step 506, the second UE determines which channel access type may be used by the second UE prior to its transmission in the COT. In one embodiment, the second UE performs LBT or channel access operation prior to its transmissions according to the channel access type indicated in the configuration information.

Alternatively, the second UE may determine to choose a similar category of LBT operation as the one that the first UE has applied to initiate the COT.

Thereafter, where the second UE has determined to occupy the COT, the second UE uses the determined channel access type (LBT operations) to occupy the COT and perform its own transmissions, e.g., to the first UE.

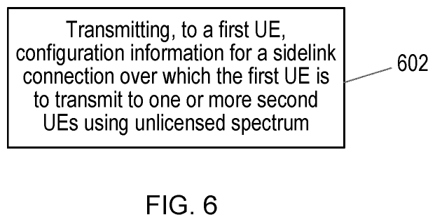

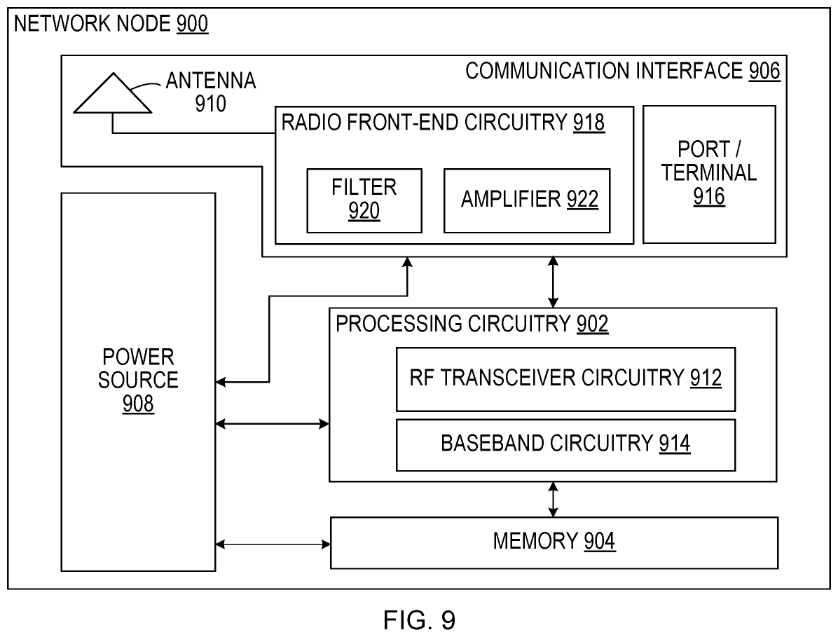

FIG. 6 depicts a method in accordance with particular embodiments. The method may be performed by a network node (e.g. the network node 710 or network node 900 as described later with reference to FIGS. 7 and 9 respectively).

The method begins at step 602 in which the network node transmits, to a first UE (e.g., a UE which is served by the network node), configuration information for a sidelink connection from the first UE to one or more second UEs, particularly where the sidelink connection uses unlicensed spectrum.

The configuration information may be transmitted together with a grant of resources (on unlicensed spectrum) for the first UE to use when transmitting to the one or more second UEs (e.g., indicated in downlink control information (DCI) transmitted on a downlink control channel such as PDCCH), or when configuring one or more resource pools from which the first UE selects resources for its transmissions over the sidelink connection.

For example, when the first UE obtains dynamic SL grants via Mode 1 resource allocation, i.e., the network node assigns the SL grants to the UE, the network node may additionally indicate one or more of the following parameters to the UE:
Channel access categories/LBT types that the UE shall apply prior to transmissions using the grants. Examples of channel access categories include: not performing a clear channel assessment; switching between transmitting and receiving transmissions over the sidelink connection during the channel occupancy time without performing a clear channel assessment; performing a clear channel assessment prior to transmitting over the sidelink connection; performing a clear channel assessment and performing random back-off with a fixed-size contention window prior to transmitting over the sidelink connection; performing a clear channel assessment and performing random back-off with a variable-sized contention window prior to transmitting over the sidelink connection.
Channel access priority classes that the UE shall apply for the selected channel access category/LBT type prior to transmissions using the grants. Each channel access priority class (CAPC) may define one or more of: a defer time (e.g., the length of time the channel should be sensed as being idle before being deemed idle); a minimum contention window size; a maximum contention window size; a maximum COT duration.
Whether cyclic prefix (CP) extension is enabled and how CP extension is performed. The CP may be extended to align a channel sensing interval with an OFDM symbol boundary, or to give UEs more time before switching from DL to UL.

This information may be provided in the same message as the grant of resources, e.g., in the DCI on the PDCCH (e.g., with Format 3_0 or Format 3_1)

In the case of configured grant Mode 1, the network node may indicate at least one of the above configuration information parameters (e.g., channel access categories or LBT types; CAPC; and/or CP extension information) in RRC signaling.

Where the network node assigns more than one SL grant to the first UE, this information (e.g., the channel access categories or LBT types, etc) may be different for different SL transmissions. In other words, prior to the first SL transmission, the UE may apply a first LBT type, whereas prior to a subsequent SL transmission, a second LBT type different from the first LBT type may be applied.

Thus the channel access priority class for the transmission over the sidelink connection may be signalled to the first UE.

The Channel Access Priority Classes (CAPC) of radio bearers and MAC CEs may be fixed or configurable. For example, where the transmission comprises signalling radio bearers (SRBs) and/or MAC control elements (CES) the CAPCs may be fixed to the highest priority of the possible values for CAPC.

Alternatively, a specific type of SRB or MAC CE may be fixed or configured to a specific priority or CAPC, e.g., perhaps not the highest value.

The priority and/or CAPC for any SRB or MAC CE may be configured to the first UE by the gNB or another controlling UE. The configured priority can override any existing preconfigured/fixed priority value.

When choosing the CAPC of a data radio bearer (DRB), the network node may take into account quality-of-service parameters associated with the flows multiplexed in that DRB, such as the SL 5G QOS parameters, e.g., PC5 QOS Identifier (PQI), where PC5 is the interface between UEs. The network node may additionally consider fairness between different traffic types and transmissions.

Four possible mappings between CAPC values and QoS parameters (which is PQI in the examples) are shown in Tables 1 to 4 above. The tables thus show which CAPC should be used for which standardized PQIs, i.e., which CAPC to use for a given QoS flow.

NOTE: A QoS flow corresponding to a non-standardized PQI (i.e. operator specific PQI) may use the CAPC of the standardized PQI which best matches the QoS characteristics of the non-standardized PQI.

The table may be defined considering one or more of the following
The priority level of the flow
The packet delay budget (PDB) of the flow
The packet error rate (PER) of the flow

Any embodiment is restricted to any example. The embodiments are also applicable to any other variant of the table.

The tables may be applicable to any SL grant including dynamic grant, configured SL grants (including Type 1 configured grant, and Type 2 configured grant), or SL grants obtained by the UE itself via Mode 2 resource allocation.

The tables may be applicable by the first UE to determine or select CAPC for a SL transmission when the CAPC is not indicated/signaled to the UE by the gNB or another controlling UE, in other words, for a flow/DRB associated with a PQI, any configured/signaled CAPC value may override the CAPC value defined in the table. Alternatively, the tables may be used by the network node to determine appropriate CAPC values for transmissions to be performed by the first UE.

There may be one or multiple tables defined to the UE. In the latter embodiments, different tables may be applicable to different scenarios. For example, different tables may apply in differing radio conditions, differing network loads, for transmissions to differing types of UE (e.g., non-machine-type UEs, machine-type UEs, etc), etc. The tables may be signalled to the first UE as part of the configuration information, or preconfigured in the first UE.

When the UE selects the CAPC from a table for a transmission of a MAC PDU/TB, the UE may select the CAPC according to the following rules:
If only MAC CE(s) are included in the TB, the highest priority CAPC of those MAC CE(s) is used; or
If SDU(s) of a SRB are included in the TB, the highest priority CAPC is used; or
If there is a LCH priority threshold configured, the highest priority CAPC of the logical channel(s) with LCH priority above the LCH priority threshold, and with MAC SDU multiplexed in the TB is used; or
If there is no LCH priority threshold configured, the highest priority CAPC of the logical channel(s) with MAC SDU multiplexed in the TB is used.

The following description sets out additional embodiments of the disclosure, and should be read in conjunction with the description above.

As a first embodiment, for a SL capable UE which performs SL transmissions on unlicensed band, when the UE obtains dynamic SL grants via Mode 1 resource allocation, i.e., the gNB assigns the SL grants to the UE, the gNB indicates at least one of the following information to the UE in the DCI on the PDCCH (e.g., with Format 3_0 or Format 3_1)
Channel access categories/LBT types that the UE shall apply prior to transmissions using the grants
Channel access priority classes that the UE shall apply for the selected channel access category/LBT type prior to transmissions using the grants
Whether CP extension is enabled and how CP extension is performed

In case of configured grant Type 1, the gNB may indicate at least one of the above information in the RRC signaling. Upon reception of the information/signaling from the gNB, the UE performs channel access/LBT according to the received signaling prior to initiating SL transmissions using the SL grants.

In case the gNB assigns more than SL grants to the UE, the channel access categories or LBT types may be different for different SL transmissions. In other words, prior to the first SL transmission, the UE applies a LBT type, while for the subsequent SL transmissions, the LBT types may be different from the one which is applied for the first SL transmission.

As a second embodiment, the Channel Access Priority Classes (CAPC) of radio bearers and MAC CEs are either fixed or configurable:
Fixed to the highest priority for SRBs and MAC CEs;

In an example, a specific type of SRB or MAC CE may be fixed or configured to a specific priority, e.g., may be not the highest priority.

In an example, the priority for any SRB or MAC CE may be configured to a UE by the gNB or another controlling UE. The configured priority can override any existing preconfigured/fixed priority value.

When choosing the CAPC of a DRB, the gNB takes into account the SL 5G QOS parameters (e.g., PQI) of all the QoS flows multiplexed in that DRB while considering fairness between different traffic types and transmissions.

As an example, Table 1 (above) shows which CAPC should be used for which standardized PQIs i.e. which CAPC to use for a given QoS flow.

NOTE: A QoS flow corresponding to a non-standardized PQI (i.e. operator specific PQI) should use the CAPC of the standardized PQI which best matches the QoS characteristics of the non-standardized PQI.

Other examples are shown in Tables 2, 3 and 4.

The table may be defined considering at least one of the following
The priority level of the flow
The PDB of the flow
The PER of the flow

Any embodiment is restricted to any example. The embodiments are also applicable to any other variant of the table.

The table is applicable to any SL grant including dynamic grant, configured SL grants (including Type 1 configured grant, and Type 2 configured grant), or SL grants obtained by the UE itself via Mode 2 resource allocation.

The table is applicable by the UE to determine or select CAPC for a SL transmission when the CAPC is not indicated/signaled to the UE by the gNB or another controlling UE, in other words, for a flow/DRB associated with a PQI, any configured/signaled CAPC value may override the CAPC value defined in the table.

There may be one or multiple tables defined to the UE. Among all the tables, each of them is applicable to different scenarios/conditions.

When the UE selects the CAPC from a table for a transmission of a MAC PDU/TB, the UE shall select the CAPC as follows:
If only MAC CE(s) are included in the TB, the highest priority CAPC of those MAC CE(s) is used; or
If SDU(s) of a SRB are included in the TB, the highest priority CAPC is used; or
If there is a LCH priority threshold configured, the highest priority CAPC of the logical channel(s) with LCH priority above the LCH priority threshold, and with MAC SDU multiplexed in the TB is used; or
If there is no LCH priority threshold configured, the highest priority CAPC of the logical channel(s) with MAC SDU multiplexed in the TB is used.

As a third embodiment, upon obtaining of an SL grant, the UE determines the channel access type for the SL grant and signals at least one of the following information to the UEs in the proximity
Channel access category/LBT type that the UE has performed to initiate the COT
CAPC of the LBT category that the UE has performed to initiate the COT
Whether COT is allowed to be shared
In case the COT is shared to the other UEs, channel access category/LBT type is allowed to use by the other UEs prior to their transmissions when occupying the COT
In case the COT is shared to the other UEs, whether CP extension is enabled and how CP extension is performed by the other UEs prior to their transmissions when occupying the COT

At least one of the following information type via at least one of the following signaling prior to initiating the SL transmission using the SL grant

MAC CE. MAC CE may be transmitted ahead of the SL transmission using another grant. Alternatively, the MAC CE is transmitted together with the data using the SL grant.

L1 signaling on channels such as PSSCH, PSCCH. The signaling may be carried in the SCI

Upon reception of the signaling, the neighbor UEs in the proximity learns about the channel access type that will be used by the upcoming transmission by the UE. The COT sharing related information as described in the first embodiment may be also carried in the signaling in the SL link (e.g., SCI). based on the information received by other UEs, the other UE may consider this information for determining at least one of the following
Whether to join/occupy the COT if it is shared by the UE
What channel access type may be chosen by the other UE prior to its transmissions

If the COT is shared by the UE, the other UE may determine to occupy the COT for its subsequent data transmission or reception, in this case, the other UE performs LBT operation prior to its transmissions according to the channel access type indicated in the signaling.

Regardless of whether the COT is shared by the UE, the other UE may determine to choose which channel access type to use for its subsequent transmission according to one or more of the following rules:
If the gap from the end of the last transmission of the UE to the beginning of the next transmission of the other UE is not more than Xus, the other UE chooses category 1 LBT; else
If the gap from the end of the last transmission of the UE to the beginning of the next transmission of the other UE is not more than Yus, the other UE chooses category 2 LBT with duration equal to Zus (Z<=Y).
Otherwise, the other UE may choose Category 3 or category 4 LBT.

Alternatively, the other UE may determine to choose a similar category of LBT operation as the one that the UE has applied to initiate the COT.

Note: for any one of the above embodiments, it is assumed that LBE mode is applied for channel access.

As a fourth embodiment, in case FBE mode is applied for channel access, the following information/setting may also be signaled/configured to the UE in any one of the signaling alternatives described in the above embodiments:
fixed frame period (FFP)

In addition, the gNB may provide the configuration to the UE via RRC signaling, or in the system information.

For UEs that are out of coverage, the above information/setting may also or alternatively be preconfigured in or to the UE.

In addition to any signaling alternative described in the above embodiments, the channel access mode (i.e., LBE or FBE) may be also configured to the UE by the gNB via RRC signaling, or in the system information.

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections. It will further be apparent from the discussion above and the disclosure as a whole that two or more of the UEs 712 may be operative to transmit directly to each other via a sidelink connection, for example as part of a relay operation in which one UE (e.g., with low or poor connectivity to a network node 710) transmits information to the network via another UE. Alternatively, the two or more UEs may be configured to perform device-to-device (D2D) communications. The sidelink connection may be configured by one or more network nodes 710.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 7, the hub 714 communicates with the access network 704 to facilitate indirect communication between one or more UEs (e.g., UE 712c and/or 712d) and network nodes (e.g., network node 710b). In some examples, the hub 714 may be a controller, router, a content source and analytics node, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd

Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs). The processing circuitry 802 may be operable to provide, either alone or in conjunction with other UE 800 components, such as the memory 810, UE 800 functionality. For example, the processing circuitry 802 may be configured to cause the UE 802 to perform the methods as described with reference to FIGS. 4 and 5.

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In some embodiments, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes processing circuitry 902, a memory 904, a communication interface 906, and a power source 908, and/or any other component, or any combination thereof. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, network node 900 functionality. For example, the processing circuitry 902 may be configured to cause the network node to perform the methods as described with reference to FIG. 6.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

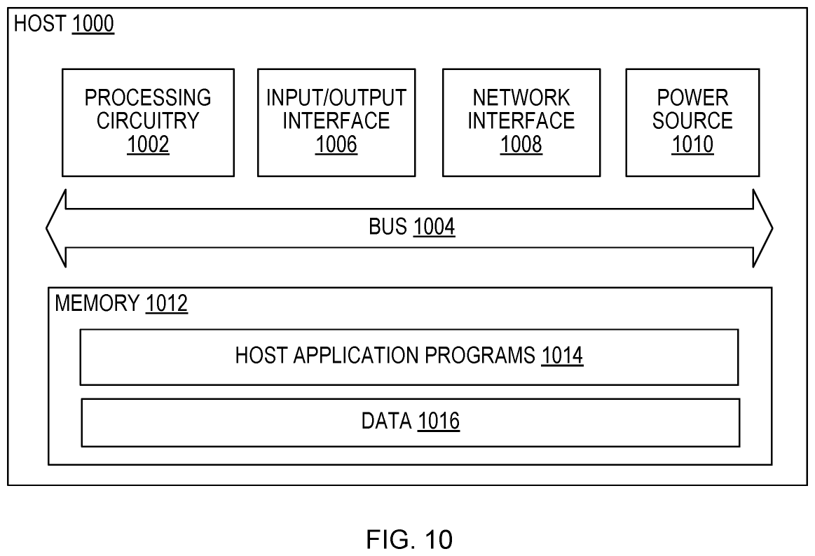

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

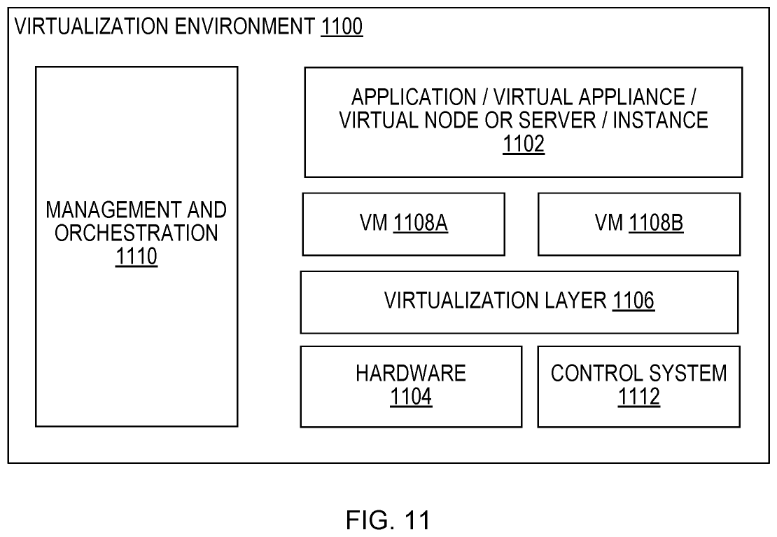

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

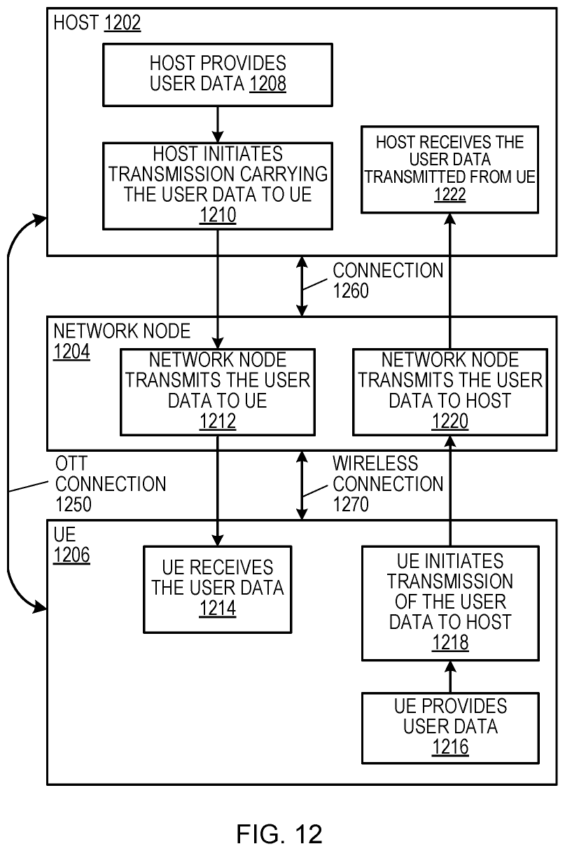

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve the reliability of sidelink connections and thereby provide benefits such as improved local content, better co-ordination between UEs in proximity to one another, etc.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1x RTT CDMA2000 1x Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LAA License-Assisted Access
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network
   For the avoidance of doubt, the following numbered statements set out embodiments of the disclosure:
1. A method performed by a first user equipment, UE, the method comprising:
   determining resources in unlicensed spectrum on which to transmit to one or more second UEs over a sidelink connection; and
   using the determined resources to initiate a transmission within a channel occupancy time.
2. The method of embodiment 1, wherein determining resources in unlicensed spectrum comprises receiving, from a network node, a grant of the resources on which to transmit to the one or more second UEs over the sidelink connection.
3. The method of embodiment 1 or 2, further comprising receiving, from the network node, an indication of a channel access category that shall be applied when using the resources.
4. The method of embodiment 3, wherein the channel access category defines a listen-before-talk, LBT, procedure that shall be applied by the first UE when using the resources.
5. The method of embodiment 4, wherein the LBT procedure comprises one of: not performing a clear channel assessment; switching between transmitting and receiving transmissions over the sidelink connection during the channel occupancy time without performing a clear channel assessment; performing a clear channel assessment prior to transmitting over the sidelink connection; performing a clear channel assessment and performing random back-off with a fixed-size contention window prior to transmitting over the sidelink connection; performing a clear channel assessment and performing random back-off with a variable-sized contention window prior to transmitting over the sidelink connection.
6. The method of any one of the preceding embodiments, further comprising determining a channel access priority class for the transmission.
7. The method of embodiment 6, wherein determining the channel access priority class for the transmission comprises receiving, from the network node, an indication of the channel access priority class for the transmission.
8. The method of embodiment 6, wherein determining the channel access priority class for the transmission comprises:
   determining quality of service indicators associated with one or more of: one or more radio bearers belonging to the transmission; and one or more medium access control, MAC, control elements belonging to the transmission, and
   mapping the determined quality of service indicators to the channel access priority class for the transmission.
9. The method of embodiment 8, wherein, responsive to a determination that the transmission comprises a plurality of MAC control elements and no radio bearers, the channel access priority class for the transmission is set to correspond to the channel access priority class of the plurality of MAC control elements having the highest priority.
10. The method of embodiment 8 or 9, wherein, responsive to a determination that the transmission comprises at least one signalling radio bearer, the channel access priority class for the transmission is set to the highest priority.
11. The method of any one of embodiments 8 to 10, wherein, responsive to a determination that the transmission includes one or more radio bearers and one or more MAC control elements and that the first UE is configured with a logical channel priority threshold, the channel access priority class for the transmission is set to the highest priority of those logical channels with a logical channel priority above the logical channel priority threshold.

12. The method of any one of embodiments 8 to 11, wherein, responsive to a determination that the transmission includes one or more radio bearers and one or more MAC control elements and that the first UE is not configured with a logical channel priority threshold, the channel access priority class for the transmission is set to the highest priority of the logical channels.
13. The method of any one of the preceding embodiments, further comprising transmitting, to the one or more second UEs over the sidelink connection, configuration information for the channel occupancy time.
14. The method of embodiment 13, wherein the configuration information comprises one or more of: an indication of a channel access category that was used by the first UE to initiate the channel occupancy time; a channel access priority class that applies to the channel occupancy time; an indication of whether the channel occupancy time is permitted to be shared between the first UE and any of the one or more second UEs; an indication of the channel access category that is to be applied by second UEs prior to their occupying the channel occupancy time; an indication of whether cyclic prefix extension is to be applied by second UEs prior to their occupying the channel occupancy time.
15. The method of any one of the preceding embodiments, wherein the first UE is operative in a frame-based equipment, FBE mode, further comprising receiving, from the network node, an indication of a fixed frame period for the sidelink connection.
16. A method performed by a second user equipment, UE, the method comprising:
   receiving, from a first UE over a sidelink connection using unlicensed spectrum, configuration information for a channel occupancy time within which the first UE is to transmit on the sidelink connection.
17. The method according to embodiment 16, wherein the configuration information comprises one or more of: an indication of a channel access category that is used by the first UE to initiate the transmission within the channel occupancy time; a channel access priority class that applies to the channel occupancy time; an indication of whether the channel occupancy time is permitted to be shared between the first UE and any of the one or more second UEs; an indication of the channel access category that is to be applied by second UEs prior to their occupying the channel occupancy time; an indication of whether cyclic prefix extension is to be applied by second UEs prior to their occupying the channel occupancy time.
18. The method of embodiment 16 or 17, further comprising, based on the configuration information, determining whether to occupy the channel occupancy time for transmissions by the second UE to the first UE.
19. The method of embodiment 18, further comprising, responsive to a determination to occupy the channel occupancy time, determining which channel access category to apply when occupying the channel occupancy time.
20. The method of embodiment 19, wherein determining which channel access category to apply comprises determining which channel access category to apply based on the configuration information.
21. The method of any one of embodiments 16 to 18, further comprising determining which channel access category to apply based on a time gap between an end of a final transmission by the first UE and a start of an initial transmission by the second UE.
22. The method of embodiment 21, wherein determining which channel access category to apply comprises comparing the time gap to one or more thresholds.
23. The method of any of the previous embodiments, further comprising:
   providing user data; and
   forwarding the user data to a host via the transmission to the network node.
24. A method performed by a network node, the method comprising:
   transmitting, to a first user equipment, UE, configuration information for a sidelink connection over which the first UE is to transmit to one or more second UEs using unlicensed spectrum.
25. The method of embodiment 24, wherein the configuration information comprises a channel access priority class for a transmission over the sidelink connection.
26. The method of embodiment 25, wherein determining the channel access priority class for the transmission comprises:
   determining quality of service indicators associated with one or more of: one or more radio bearers belonging to the transmission; and one or more medium access control, MAC, control elements belonging to the transmission, and
   mapping the determined quality of service indicators to the channel access priority class for the transmission.
27. The method of embodiment 26, wherein, responsive to a determination that the transmission comprises a plurality of MAC control elements and no radio bearers, the channel access priority class for the transmission is set to correspond to the channel access priority class of the plurality of MAC control elements having the highest priority.
28. The method of embodiment 26 or 27, wherein, responsive to a determination that the transmission comprises at least one signalling radio bearer, the channel access priority class for the transmission is set to the highest priority.
29. The method of any one of embodiments 26 to 28, wherein, responsive to a determination that the transmission includes one or more radio bearers and one or more MAC control elements and that the first UE is configured with a logical channel priority threshold, the channel access priority class for the transmission is set to the highest priority of those logical channels with a logical channel priority above the logical channel priority threshold.
30. The method of any one of embodiments 26 to 29, wherein, responsive to a determination that the transmission includes one or more radio bearers and one or more MAC control elements and that the first UE is not configured with a logical channel priority threshold, the channel access priority class for the transmission is set to the highest priority of the logical channels.
31. The method of any one of embodiments 24 to 30, wherein the first UE is operative in a frame-based equipment, FBE mode, and further comprising transmitting, to the first UE, an indication of a fixed frame period for the sidelink connection.
32. The method of any one of embodiments 24 to 31, wherein the configuration information comprises an indication of resources in unlicensed spectrum granted to the first UE for the transmission to the one or more second UEs.
33. The method of any one of embodiments 24 to 32, wherein the configuration information comprises an indication of a channel access category that shall be applied when transmitting to the one or more second UEs.
34. The method of embodiment 33, wherein the channel access category defines a listen-before-talk, LBT, procedure that shall be applied by the first UE when using the resources.
35. The method of embodiment 34, wherein the LBT procedure comprises one of: not performing a clear channel assessment; switching between transmitting and receiving transmissions over the sidelink connection during a channel occupancy time without performing a clear channel assessment; performing a clear channel assessment prior to transmitting over the sidelink connection; performing a clear channel assessment and performing random back-off with a fixed-size contention window prior to transmitting over the sidelink connection; performing a clear channel assessment and performing random back-off with a variable-sized contention window prior to transmitting over the sidelink connection.
36. The method of any one of embodiments 24 to 35, wherein the configuration information comprises an indication of whether cyclic prefix extension is to be applied by the first UE between transmitting and receiving to the one or more second UEs over the sidelink connection.
37. The method of any of the previous embodiments, further comprising:
   obtaining user data; and
   forwarding the user data to a host or a user equipment.
38. A user equipment, comprising:
   processing circuitry configured to cause the user equipment to perform any of the steps of any of embodiments 1 to 23; and
   power supply circuitry configured to supply power to the processing circuitry.
39. A network node, the network node comprising:
   processing circuitry configured to cause the network node to perform any of the steps of any of embodiments 24 to 37;
   power supply circuitry configured to supply power to the processing circuitry.
40. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of embodiments 1 to 23;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
41. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of embodiments 1 to 23 to receive the user data from the host.
42. The host of embodiment 41, wherein the cellular network further includes a network node configured to communicate with the UE to transmit the user data to the UE from the host.
43. The host of embodiment 41 or 42, wherein:
   the processing circuitry of the host is configured to execute a host application, thereby providing the user data; and
   the host application is configured to interact with a client application executing on the UE, the client application being associated with the host application.
44. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of embodiments 1 to 23 to receive the user data from the host.
45. The method of embodiment 44, further comprising:
   at the host, executing a host application associated with a client application executing on the UE to receive the user data from the UE.
46. The method of embodiment 45, further comprising:
   at the host, transmitting input data to the client application executing on the UE, the input data being provided by executing the host application,
   wherein the user data is provided by the client application in response to the input data from the host application.
47. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of embodiments 1 to 23 to transmit the user data to the host.
48. The host of embodiment 47, wherein the cellular network further includes a network node configured to communicate with the UE to transmit the user data from the UE to the host.
49. The host of embodiment 47 or 48, wherein:
   the processing circuitry of the host is configured to execute a host application, thereby providing the user data; and
   the host application is configured to interact with a client application executing on the UE, the client application being associated with the host application.
50. A method implemented by a host configured to operate in a communication system that further includes a network node and a user equipment (UE), the method comprising:
   at the host, receiving user data transmitted to the host via the network node by the UE, wherein the UE performs any of the steps of any of embodiments 1 to 23 to transmit the user data to the host.
51. The method of embodiment 50, further comprising:
   at the host, executing a host application associated with a client application executing on the UE to receive the user data from the UE.
52. The method of embodiment 51, further comprising:
   at the host, transmitting input data to the client application executing on the UE, the input data being provided by executing the host application,
   wherein the user data is provided by the client application in response to the input data from the host application.
53. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of embodiments 24 to 37 to transmit the user data from the host to the UE.
54. The host of embodiment 53, wherein:
   the processing circuitry of the host is configured to execute a host application that provides the user data; and
   the UE comprises processing circuitry configured to execute a client application associated with the host application to receive the transmission of user data from the host.
55. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of embodiments 24 to 37 to transmit the user data from the host to the UE.
56. The method of embodiment 55, further comprising, at the network node, transmitting the user data provided by the host for the UE.
57. The method of embodiment 55 or 56, wherein the user data is provided at the host by executing a host application that interacts with a client application executing on the UE, the client application being associated with the host application.
58. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of embodiments 24 to 37 to transmit the user data from the host to the UE.
59. The communication system of embodiment 58, further comprising:
   the network node; and/or
   the user equipment.
60. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of embodiments 24 to 37 to receive the user data from a user equipment (UE) for the host.
61. The host of embodiment 60, wherein:
   the processing circuitry of the host is configured to execute a host application, thereby providing the user data; and
   the host application is configured to interact with a client application executing on the UE, the client application being associated with the host application.
62. The host of embodiment 60 or 61, wherein the initiating receipt of the user data comprises requesting the user data.
63. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of embodiments 24 to 37 to receive the user data from the UE for the host.
64. The method of embodiment 63, further comprising at the network node, transmitting the received user data to the host.

1-40. (canceled)

41. A method performed by a first user equipment (UE), the method comprising:
determining resources in unlicensed spectrum on which to transmit to one or more second UEs over a sidelink connection; and
using the determined resources to initiate a transmission within a channel occupancy time.

42. The method of claim 41, further comprising determining a channel access priority class for the transmission.

43. The method of claim 42, wherein determining the channel access priority class for the transmission comprises:
determining quality of service indicators associated with one or more of: one or more radio bearers belonging to the transmission; and one or more medium access control (MAC) control elements belonging to the transmission, and
mapping the determined quality of service indicators to the channel access priority class for the transmission.

44. The method of claim 43, wherein, responsive to a determination that the transmission comprises a plurality of MAC control elements and no radio bearers, the channel access priority class for the transmission is set to correspond to the channel access priority class of the plurality of MAC control elements having the highest priority.

45. The method of claim 43, wherein, responsive to a determination that the transmission comprises at least one signalling radio bearer, the channel access priority class for the transmission is set to the highest priority.

46. The method of claim 43, wherein, responsive to a determination that the transmission includes one or more radio bearers and one or more MAC control elements and that the first UE is configured with a logical channel priority threshold, the channel access priority class for the transmission is set to the highest priority of those logical channels with a logical channel priority above the logical channel priority threshold.

47. The method of claim 43, wherein, responsive to a determination that the transmission includes one or more radio bearers and one or more MAC control elements and that the first UE is not configured with a logical channel priority threshold, the channel access priority class for the transmission is set to the highest priority of the logical channels.

48. The method of claim 41, further comprising transmitting, to the one or more second UEs over the sidelink connection, configuration information for the channel occupancy time.

49. The method of claim 48, wherein the configuration information comprises one or more of: an indication of a channel access category that was used by the first UE to initiate the channel occupancy time; a channel access priority class that applies to the channel occupancy time; an indication of whether the channel occupancy time is permitted to be shared between the first UE and any of the one or more second UEs; an indication of the channel access category that is to be applied by second UEs prior to their occupying the channel occupancy time; or an indication of whether cyclic prefix extension is to be applied by second UEs prior to their occupying the channel occupancy time.

50. The method of claim 41, wherein the first UE is operative in a frame-based equipment (FBE) mode, wherein the method further comprises receiving, from a network node, an indication of a fixed frame period for the sidelink connection.

51. A first user equipment (UE), comprising:
processing circuitry configured to cause the first user equipment to:
determine resources in unlicensed spectrum on which to transmit to one or more second UEs over a sidelink connection; and
use the determined resources to initiate a transmission within a channel occupancy time.

52. The first UE of claim 51, wherein the processing circuitry is further configured to cause the first UE to determine a channel access priority class for the transmission.

53. The first UE of claim 52, wherein the processing circuitry is configured to cause the first UE to determine the channel access priority class for the transmission by:
determining quality of service indicators associated with one or more of: one or more radio bearers belonging to the transmission; and one or more medium access control (MAC) control elements belonging to the transmission, and
mapping the determined quality of service indicators to the channel access priority class for the transmission.

54. The first UE of claim 53, wherein, responsive to a determination that the transmission comprises a plurality of MAC control elements and no radio bearers, the channel access priority class for the transmission is set to correspond to the channel access priority class of the plurality of MAC control elements having the highest priority.

55. The first UE of claim 53, wherein, responsive to a determination that the transmission comprises at least one signalling radio bearer, the channel access priority class for the transmission is set to the highest priority.

56. The first UE of claim 53, wherein, responsive to a determination that the transmission includes one or more radio bearers and one or more MAC control elements and that the first UE is configured with a logical channel priority threshold, the channel access priority class for the transmission is set to the highest priority of those logical channels with a logical channel priority above the logical channel priority threshold.

57. The first UE of claim 53, wherein, responsive to a determination that the transmission includes one or more radio bearers and one or more MAC control elements and that the first UE is not configured with a logical channel priority threshold, the channel access priority class for the transmission is set to the highest priority of the logical channels.

58. The first UE of claim 51, wherein the processing circuitry is further configured to cause the first UE to transmit, to the one or more second UEs over the sidelink connection, configuration information for the channel occupancy time.

59. The first UE of claim 58, wherein the configuration information comprises one or more of: an indication of a channel access category that was used by the first UE to initiate the channel occupancy time; a channel access priority class that applies to the channel occupancy time; an indication of whether the channel occupancy time is permitted to be shared between the first UE and any of the one or more second UEs; an indication of the channel access category that is to be applied by second UEs prior to their occupying the channel occupancy time; or an indication of whether cyclic prefix extension is to be applied by second UEs prior to their occupying the channel occupancy time.

60. The first UE of claim 51, wherein the first UE is operative in a frame-based equipment (FBE) mode, and wherein the processing circuitry is further configured to cause the first UE to receive, from a network node, an indication of a fixed frame period for the sidelink connection.
